(19) United States
(12) Patent Application Publication
(10) Pub. No.: US 2026/0341835 A1
(43) Pub. Date: Oct. 29, 2026

(54) Nested Manifold

(71) Applicant: Lithos Energy, Inc., Hayward, CA (US)

(72) Inventors: Colin Haag, Columbus, OH (US); Robert Wayne Sweney, Oakland, CA (US); Noam Goldberg, Richmond, CA (US)

(21) Appl. No.: 19/189,235

(22) Filed: Apr. 24, 2025

(51) Int. Cl. H01M 10/6556; H01M 10/613

(52) U.S. Cl. CPC H01M 10/6556; H01M 10/613

(57) ABSTRACT

A manifold for distributing a fluid is disclosed. The manifold comprises a first fitting with a first end and a second end. The first end comprises a pipe interface with a first internal diameter, through which a fluid flows. The second end comprises a chamber in which the first internal diameter increases to a second internal diameter. The manifold further comprises a second fitting with an external surface which complements an inner surface of the chamber of the first fitting. A pipe interface with same internal diameter as the pipe interface of the first fitting. Wherein the external surface of the second fitting and the internal surface of the chamber form a distribution channel through which the fluid flows. Wherein the second fitting directs the fluid into the distribution channel.

### TECHNICAL FIELD

This disclosure relates to devices and systems for distributing fluids.

### BACKGROUND

Lithium based batteries achieve their maximum electrical performance and durability within a limited temperature range. This temperature range is generally between 20℃ and 30℃. As temperatures rise above 30℃, the cell oxidation rate increases, which causes faster degradation of the battery, decline in performance, and reduced capacity of the battery. Lithium batteries operated at temperatures over 40℃ may lead to permanent battery damage. Maintaining the temperature of the battery between 20℃ and 30℃ increases the efficiency, life, and safety of the battery.

Various devices exist for maintaining the temperature of batteries, among them are heat transfer devices which run fluids near the batteries to transfer heat between the batteries and the fluid. A fluid manifold is a device or system designed to regulate, distribute, and control the flow of fluids or gases within hydraulic, pneumatic, or industrial systems. It typically consists of a hollow structure—such as a block, pipe, or tube—with multiple inlet and outlet ports connected by valves, fittings, and pressure equipment. The manifold serves as a centralized hub for managing fluid flow, allowing a single input source to be divided into multiple outputs or vice versa.

### SUMMARY

In a first aspect, a manifold for distributing a fluid is disclosed. The manifold comprises a first fitting with a first end and a second end. The first end comprises a pipe interface with a first internal diameter, through which a fluid flows. The second end comprises a chamber in which the first internal diameter increases to a second internal diameter. The manifold further comprises a second fitting with an external surface which complements an inner surface of the chamber of the first fitting. A pipe interface with the same internal diameter as the pipe interface of the first fitting. Wherein the external surface of the second fitting and the internal surface of the chamber form a distribution channel through which the fluid flows. Wherein the second fitting directs the fluid into the distribution channel.

A pipe may connect to the pipe interface.

The pipe interface of the first fitting may be configured to allow the pipe to be angularly misaligned when the pipe is inserted into the pipe interface of the first fitting and the pipe interface of the second fitting may be configured to allow the pipe to be angularly misaligned when the pipe is inserted into the pipe interface of the second fitting.

The pipe interface of the first fitting may be configured to allow the pipe to be axially misaligned when the pipe is inserted into the pipe interface of the first fitting. The pipe interface of the second fitting may be configured to allow the pipe to be axially misaligned when the pipe is inserted into the pipe interface of the second fitting.

The manifold may include seals within the pipe interface of the first fitting and the pipe interface of the second fitting.

The first fitting and the second fitting further comprise a main conduit through which the fluid flows.

In a second aspect this disclosure provides a system for moving a fluid through a heat transfer device. The system comprises multiple heat transfer devices through which a fluid flows, a first manifold attached to each heat transfer device. The first manifold comprises a first fitting on a first side of each heat transfer device. A second fitting on a second side of each heat transfer device. A conduit comprising the first fitting and the second fitting of each heat transfer device and a pipe connecting the second fitting of each heat transfer device to the first fitting of each subsequent heat transfer device. A distribution channel which transfers the fluid from the conduit into each heat transfer device. The walls of the distribution channel are formed by the first fitting and the second fitting of each heat transfer device. The second fitting directs the fluid from the main conduit, through the distribution channel, to each heat transfer device.

The pipe may be secured to the second fitting. The pipe may be secured to the second fitting with a clip which attaches to the pipe and to the second fitting.

The first fitting may be configured to allow the pipe to be angularly misaligned when the pipe is inserted into the first fitting and wherein the second fitting is configured to allow the pipe to be angularly misaligned when the pipe is inserted into the second fitting. The first fitting may be configured to allow the pipe to be axially misaligned when the pipe is inserted into the first fitting and wherein the second fitting is configured to allow the pipe to be axially misaligned when the pipe is inserted into the second fitting.

The first fitting and the second fitting may be affixed to the heat transfer device.

The heat transfer device of the system may further comprise a second manifold. The fluid may pass from the heat transfer device through the second manifold into the conduit.

The heat transfer device may be a cooling plate. The cooling plate may be integrated into a battery module.

In a third aspect the disclosure provides a system for maintaining the temperature of a battery system. The system comprises a heat transfer device with a first manifold through which a fluid flows. The manifold comprises a first fitting and a second fitting. The first fitting is on a first side of the heat transfer device. The first fitting comprises a first end and a second end. The first end comprises a pipe interface with a first internal diameter. The second end comprises a chamber in which the first internal diameter increases to a second internal diameter. The manifold also comprises a second fitting with an external surface which complements an inner surface of the chamber of the first fitting. The external surface of the second fitting and the internal surface of the chamber of the first fitting form a distribution channel, The second fitting directs the fluid into the distribution channel.

The first fitting and the second fitting may be affixed to the heat transfer device.

The pipe interface of the first fitting is configured to allow the pipe to be angularly misaligned when the pipe is inserted into the pipe interface of the first fitting. The pipe interface of the second fitting is configured to allow the pipe to be angularly misaligned when the pipe is inserted into the pipe interface of the second fitting.

The pipe interface of the first fitting is configured to allow the pipe to be axially misaligned when the pipe is inserted into the pipe interface of the first fitting. The pipe interface of the second fitting is configured to allow the pipe to be axially misaligned when the pipe is inserted into the pipe interface of the second fitting.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a cross-section of a fluid manifold attached to a cooling plate and a connection pipe.

FIG. 2 is a cross-section of a manifold attached to a cooling plate and a connection pipe. The pipe is angularly misaligned, this angular misalignment is downward.

FIG. 3 is a cross-section of a manifold attached to a cooling plate and a connection pipe. The pipe is angularly misaligned, this angular misalignment is upward.

FIG. 4 is a cross-section of a manifold attached to a cooling plate and a connection pipe. The pipe is axially misaligned.

FIG. 5 is a rear view of a cooling plate, with an exploded view of an input fluid manifold and an exploded view of an output manifold.

FIG. 6 is a front view of a cooling plate, with an exploded view of an input fluid manifold and an exploded view of an output manifold.

FIG. 7 is a view of a cooling system with multiple cooling plates. The cooling plates each have an input manifold and an output manifold.

FIG. 8 is a cross-section view of a cooling system.

FIG. 9 is a cross-section view of the fluid connections.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

A fluid manifold is a centralized control system that distributes, regulates, or combines fluid flow (liquids or gases) across multiple pathways. It acts as an interface to streamline complex fluid systems by reducing piping and consolidating components. A fluid manifold may assist in flow distribution. A single fluid supply may be split into multiple outlets. Multiple inputs may be combined in a single outlet. A manifold may simplify the system of which it is a part by replacing multiple piping networks with a single network. Leak points may be reduced due to the decreased number of connections. Controls may also be consolidated.

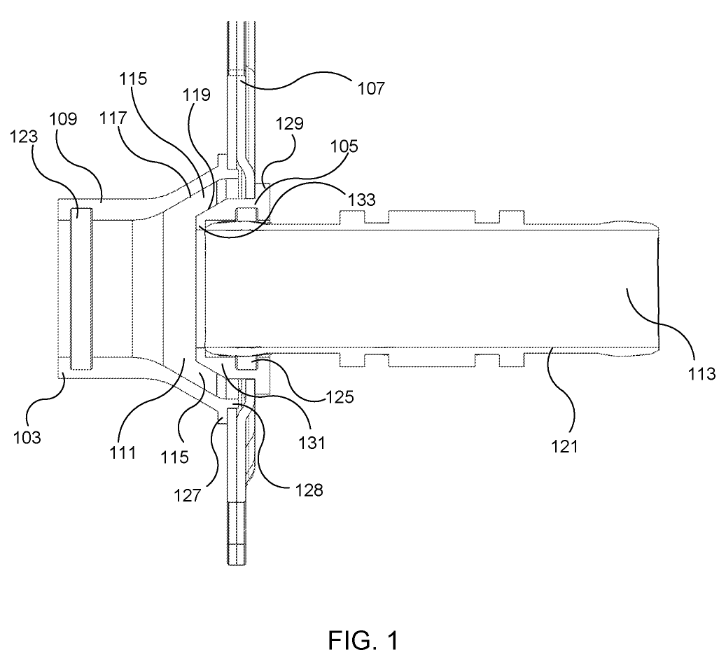

FIG. 1 is a cross-section of a fluid manifold attached to a cooling plate and a connection pipe. A fluid manifold connects to a heat transfer device, such as cooling plate 107. The fluid manifold includes a first fitting 103 on a first side of the cooling plate 107 and a second fitting 105 on a second side of the cooling plate 107. The first fitting 103 includes a pipe interface 109 with a first internal diameter. The first fitting 103 widens from the pipe interface to a chamber 111. The chamber 111 has a frustoconical shape. The second fitting 105 attaches to a second side of the cooling plate 107. The second fitting 105 has a frustoconical shape. The chamber 111 of the first fitting 103 and the second fitting 105 have complementary shapes. The frustoconical end of the second fitting 105 and the chamber 111 of the first fitting 103 are shaped to be able to nest together. The outer surface 119 of the conical portion of the second fitting 105 complements the inner surface 117 of the chamber 111 of the first fitting. The inner surface 117 and the outer surface 119 of the second fitting 105 form a distribution channel. Fluid passes through a main conduit 113, and a portion of a fluid may pass through the distribution channel 115 into the cooling plate 107. The pipe interface 109 of the first fitting accepts a pipe, through which a fluid may flow. The pipe interface 131 of the second fitting 105 also accepts a pipe 121. The pipe 121 may be inserted into the pipe interface 131 of the second fitting 105 until the pipe reaches the pipe stops 133. The pipe stops 133 prevent the pipe 121 from being inserted past the second fitting 105. In some implementations, the second fitting 105 does not have pipe stops. To ensure that the manifold does not leak, a gasket 125 seals the interface between the pipe 121 and the second fitting 105. The gasket 125 fits in a specific groove. The pipe interface 109 of the first fitting 103 also includes a groove 123 into which a gasket is placed. A pipe may be placed in the pipe interface 109. The pipes form a main conduit through which fluid passes. The first fitting 103 attaches to a first side of the cooling plate 107. The first fitting 103 includes a rim 127 and an attachment extension 128. The rim 127 and attachment extension 128 assist in sealing the first fitting 103 to the cooling plate 107. The rim 127 and attachment extension 128 fit into an opening in the cooling plate 107. The second fitting 105 attaches to a second side of the cooling plate 107. The second fitting 105 includes a rim 129 the rim 129 keeps the second fitting 105 from being inserted too far into the opening in the second side of the cooling manifold.

The fittings are used with a fluid system; therefore, the fittings and other components of the system need to be able to withstand exposure to fluids which may be corrosive and are strong enough to withstand the pressures of the system. In some embodiments, fittings, pipes and other components of the system, may be made from metals such as stainless steel, aluminum, copper, brass, or anodized aluminum. In embodiments utilizing metal for the components, the fitting may be attached by any means to establish a secure attachment. Such attachment means include welding and brazing. In some embodiments, fittings, pipes, and other components may be made from plastic, carbon fiber, or other composite materials. In embodiments utilizing composite materials, the fitting may be attached to the cooling plate by any means for attaching composites together or for attaching composite materials to metals. Such attachment methods include adhesives, ultrasonic welding or any other method for attaching the components together.

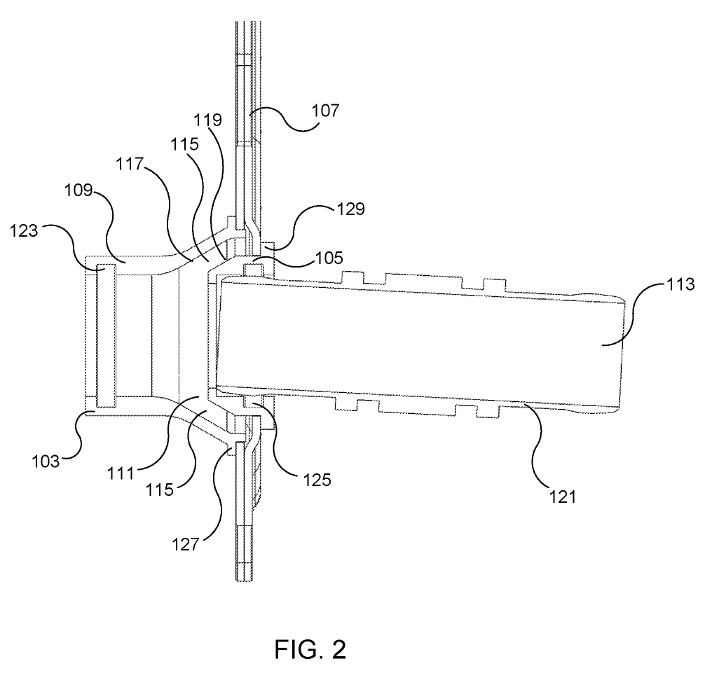

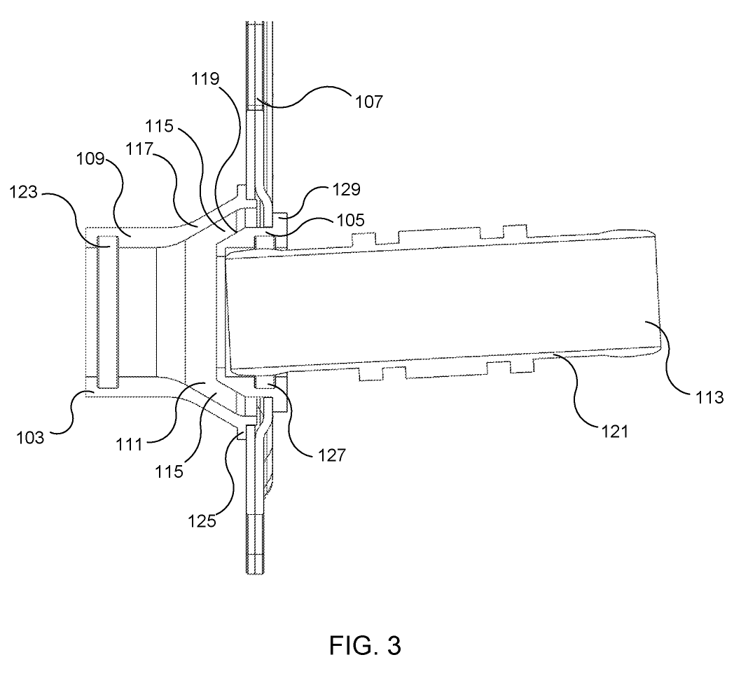

FIG. 2 is a cross-section of a manifold attached to a cooling plate and a connection pipe. The pipe is angularly misaligned, this angular misalignment is portrayed as downward. The pipe interface and the pipe are circular in cross section; therefore, the angular misalignment may be in any direction. (To visualize this in two dimensions the angular misalignment is depicted as downward.) A fluid manifold connects to a heat transfer device, such as cooling plate 107. The fluid manifold includes a first fitting 103 on a first side of the cooling plate 107 and a second fitting 105 on a second side of the cooling plate 107. The first fitting 103 includes a pipe interface 109 with a first internal diameter. The first fitting 103 widens from the pipe interface to a chamber 111. The chamber 111 has a frustoconical shape. The second fitting 105 attaches to a second side of the cooling plate 107. The second fitting 105 has a frustoconical shape. The chamber 111 of the first fitting 103 and the second fitting 105 have complementary shapes. The frustoconical end of the second fitting 105 and the chamber 111 of the first fitting 103 are shaped to be able to nest together. The outer surface 119 of the conical portion of the second fitting 105 complements the inner surface 117 of the chamber 111 of the first fitting 103. The inner surface 117 and the outer surface 119 of the second fitting 105 form a distribution channel. Fluid passes through a main conduit 113, and a portion of a fluid may pass through the distribution channel 115 into the cooling plate 107. The pipe interface 109 of the first fitting accepts a pipe, through which a fluid may flow. The pipe interface 131 of the second fitting 105 also accepts a pipe 121. The pipe 121 may be inserted into the pipe interface 131 of the second fitting 105 until the pipe reaches the pipe stops 133. The pipe stops 133 prevent the pipe 121 from being inserted past the second fitting 105. To ensure that the manifold does not leak, a gasket 125 seals the interface between the pipe 121 and the second fitting 105. The gasket 125 fits in a specific groove. The gasket may be an O-ring. The pipe interface 109 of the first fitting 103 also includes a groove 123 into which a gasket is placed. A pipe may be placed in the pipe interface 109. When the pipe 121 is inserted into the pipe interface 131 of the second fitting 105, the pipe 121 may not seat perfectly. The pipe 121 may be angularly misaligned. As both the pipe interface 131, of the second fitting 105, and the pipe are circular, the angular misalignment may be in any direction. In the depicted implementation of FIG. 3, the angular misalignment is upward. The angular misalignment may be from about 0.25 degrees to about 20 degrees. The gasket 125 seals the interface between the pipe interface 131 and the pipe 121. The gasket 125 enables the angular misalignment without allowing fluid to leak from between the pipe and the pipe interface. In addition to the pipe 121 being able to be angularly misaligned in the pipe interface 131 of the second fitting, a connection pipe may be angularly misaligned in the pipe interface of the first fitting. The

FIG. 3 is a cross-section of a manifold attached to a cooling plate and a connection pipe. The pipe is angularly misaligned, this angular misalignment is upward. The pipe interface and the pipe are circular in cross section; therefore, the angular misalignment may be in any direction. (To visualize this in two dimensions the angular misalignment is depicted as upward.) A fluid manifold connects to a heat transfer device, such as cooling plate 107. The fluid manifold includes a first fitting 103 on a first side of the cooling plate 107 and a second fitting 105 on a second side of the cooling plate 107. The first fitting 103 includes a pipe interface 109 with a first internal diameter. The first fitting 103 widens from the pipe interface to a chamber 111. The chamber 111 has a frustoconical shape. The second fitting 105 attaches to a second side of the cooling plate 107. The second fitting 105 has a frustoconical shape. The chamber 111 of the first fitting 103 and the second fitting 105 have complementary shapes. The frustoconical end of the second fitting 105 and the chamber 111 of the first fitting 103 are shaped to be able to nest together. The outer surface 119 of the conical portion of the second fitting 105 complements the inner surface 117 of the chamber 111 of the first fitting 103. The inner surface 117 and the outer surface 119 of the second fitting 105 form a distribution channel. Fluid passes through a main conduit 113, and a portion of a fluid may pass through the distribution channel 115 into the cooling plate 107. The pipe interface 109 of the first fitting accepts a pipe, through which a fluid may flow. The pipe interface 131 of the second fitting 105 also accepts a pipe 121. The pipe 121 may be inserted into the pipe interface 131 of the second fitting 105 until the pipe reaches the pipe stop 133. The pipe stops 133 prevent the pipe 121 from being inserted past the second fitting 105. To ensure that the manifold does not leak, a gasket 125 seals the interface between the pipe 121 and the second fitting 105. The gasket 125 fits in a specific groove. The gasket may be an O-ring. The pipe interface 109 of the first fitting 103 also includes a groove 123 into which a gasket is placed. A pipe may be placed in the pipe interface 109. When the pipe 121 is inserted into the pipe interface 131 of the second fitting 105, the pipe 121 may not seat perfectly. The pipe 121 may be angularly misaligned. As both the pipe interface 131, of the second fitting 105, and the pipe are circular, the angular misalignment may be in any direction. In the depicted implementation of FIG. 3, the angular misalignment is downward. The angular misalignment may be up to about 10 degrees. The gasket 125 seals the interface between the pipe interface 131 and the pipe 121. The gasket 125 enables the angular misalignment without allowing fluid to leak from between the pipe and the pipe interface.

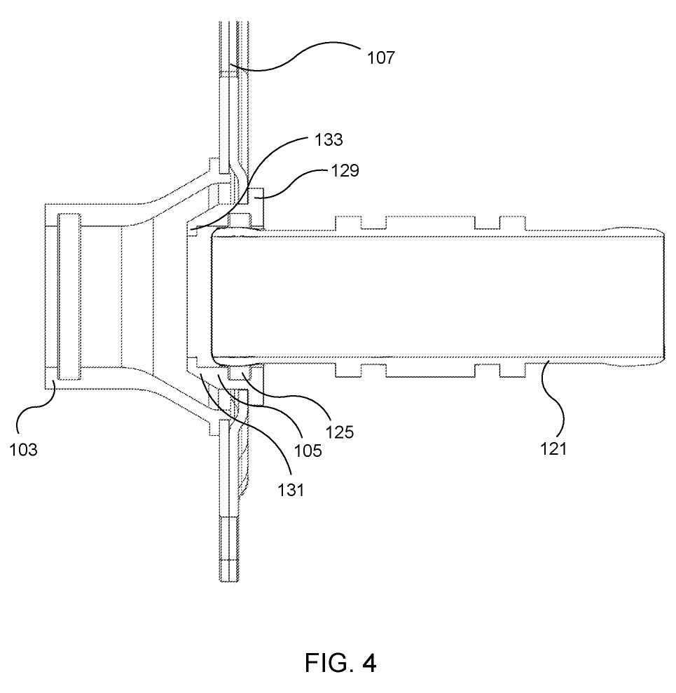

FIG. 4 is a cross-section of a manifold attached to a cooling plate and a connection pipe. The connection pipe is axially misaligned. The axial misalignment is movement in the horizontal direction. The pipe may be moved within the pipe interface 131 of the second fitting. The best fit of the pipe 121 and the second fitting 105 is when the pipe is fit to the end of the second fitting 105. In implementations where the second fitting includes pipe stop 133, the pipe 121 is inserted into the pipe interface 131 of the second fitting until the pipe encounters the pipe stop 133. In some implementations, the pipe is shorter, and the pipe may not be inserted all the way to the pipe stop. The shorter pipe may still be used because of the design which allows axial misalignment. The gasket 125 will seal the junction between the pipe interface 131 of the second fitting 105 and the pipe 121. By allowing axial misalignment, the tolerances necessary for construction and installation of the pipe 121 into the pipe interface 131 of the second fitting 105 are relaxed. The axial misalignment may be up to about 5mm in the pipe interface 131 of the second fitting 105. The pipe 121 may also be axially misaligned in the pipe interface 109 of the first fitting. The axial misalignment of the pipe in pipe interface of the first fitting may be up to about 5mm. The pipe 121 may therefore vary in length by up to 10mm. This variation in length is beneficial in manufacturing by decreasing the number of pipes that need to be rejected. The ability of the system to accept axial misalignment is also beneficial in assembling the system. During installation of the pipe 121 into the pipe interface 131, the pipe may not be installed to the pipe stop, and even with this axial misalignment, the system will function and not leak.

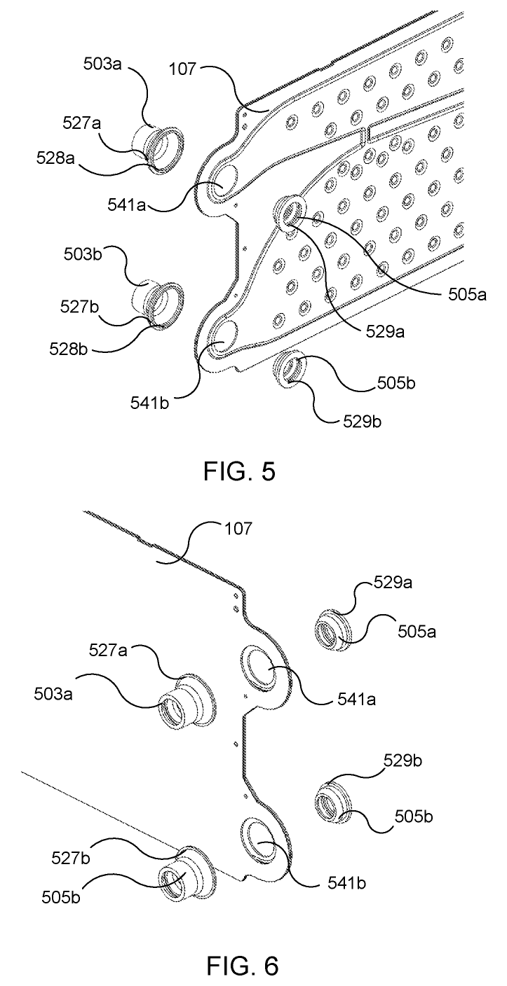

FIG. 5 is a rear view of a cooling plate, with an exploded view of an input fluid manifold and an exploded view of an output manifold. The cooling plate 107 has an input manifold through which fluid enters the cooling plate and an output manifold through which fluid exits the cooling plate. The input manifold includes the first fitting 503a which is installed on a first side of the cooling plate. An attachment extension 528afits within an aperture 541a. A rim 527aon the first fitting 503aprovides a platform for the first fitting 503a to attach to the cooling plate. The platform provided by the rim 527agives place for securing the first fitting to the cooling plate. The first fitting may be secured by welding, brazing, adhesive, or press fitting. The input manifold also includes a second fitting 505a which attaches to the second side of the cooling plate 107. The second fitting 505afits through aperture 541a. The second fitting 505 nests within the first fitting 503a. The rim 529aof the second fitting 505aprovides a platform for the second fitting 505a to attach to the second side of the cooling plate 107. The second fitting may be secured by welding, brazing, adhesive, or press fitting.

The output manifold includes first fitting 503b which is installed on a first side of the cooling plate. An attachment extension 528bfits within an aperture 541b. A rim 527bon the first fitting 503bprovides a platform for the first fitting 503b to attach to the cooling plate. The platform provided by the rim 527bgives place for securing the first fitting to the cooling plate. The first fitting may be secured by welding, brazing, adhesive, and press fitting. The output manifold also includes a second fitting 505b which attaches to the second side of the cooling plate 107. The second fitting 505bfits through aperture 541b. The second fitting 505bnests within the first fitting 503b. The rim 529bof the second fitting 505bprovides a platform for the second fitting 505b to attach to the second side of the cooling plate 107. The second fitting may be secured by welding, brazing, adhesive, or press fitting.

FIG. 6 is a front view of a cooling plate, with an exploded view of an input fluid manifold and an exploded view of an output manifold. The cooling plate 107 has an input manifold through which fluid enters the cooling plate and an output manifold through which fluid exits the cooling plate. The input manifold includes first fitting 503awhich is installed on a first side of the cooling plate. An attachment extension 528afits within an aperture 541a. A rim 527aon the first fitting 503aprovides a platform for the first fitting 503a to attach to the cooling plate. The platform provided by the rim 527agives place for securing the first fitting to the cooling plate. The first fitting may be secured by welding, brazing, adhesive, or press fitting. The input manifold also includes a second fitting 505a which attaches to the second side of the cooling plate 107. The second fitting 505a fits through aperture 541a. The second fitting 505 nests within the first fitting 503a. The rim 529aof the second fitting 505a provides a platform for the second fitting 505a to attach to the second side of the cooling plate 107. The second fitting may be secured by welding, brazing, adhesive, or press fitting.

The output manifold includes first fitting 503b which is installed on a first side of the cooling plate. An attachment extension 528bfits within an aperture 541b. A rim 527bon the first fitting 503bprovides a platform for the first fitting 503b to attach to the cooling plate. The platform provided by the rim 527b gives place for securing the first fitting to the cooling plate. The first fitting may be secured by welding, brazing, adhesive, and press fitting. The output manifold also includes a second fitting 505b which attaches to the second side of the cooling plate 107. The second fitting 505bfits through aperture 541b. The second fitting 505bnests within the first fitting 503b. The rim 529bof the second fitting 505bprovides a platform for the second fitting 505b to attach to the second side of the cooling plate 107. The second fitting may be secured by welding, brazing, adhesive, or press fitting.

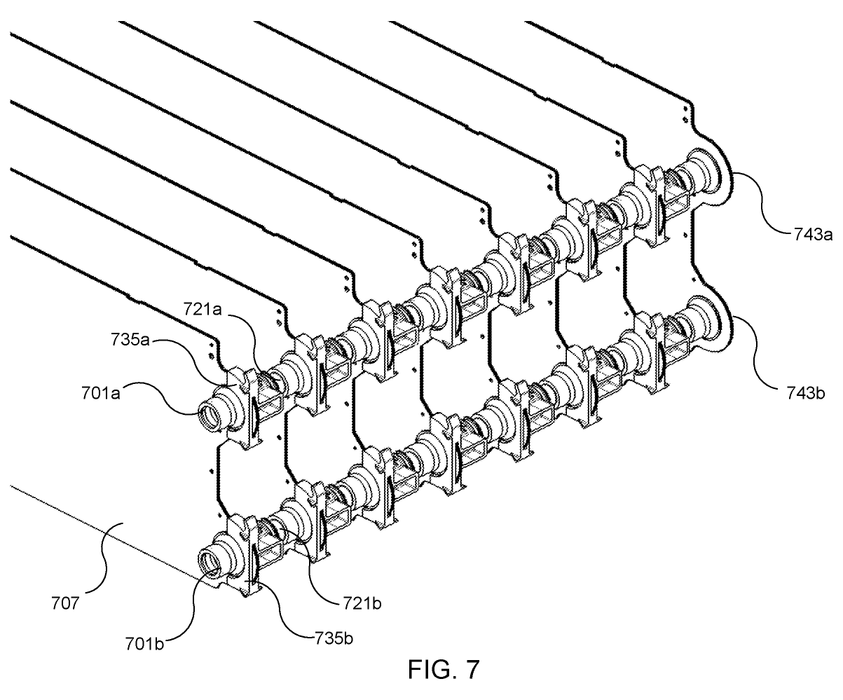

FIG. 7 is a view of a cooling system with multiple cooling plates. The cooling plates each have an input manifold and an output manifold. The input manifolds are connected by connecting pipes such as connecting pipe 721a. The connecting pipes, such as connecting pipe 721a, are secured to the fluid manifolds by clips, such as clip 735a. The input manifolds and connecting pipes form a main conduit through which fluid flows. The end of the main conduit is capped by cap 743a. The fluid is diverted from the main conduit into the cooling plates by the second fitting of the input manifolds. The fluid flows through the cooling plate, such as cooling plate 107, to the outlet manifold 701b. The fluid is directed to a main conduit by the second fitting of the outlet manifold. The main conduit is formed by connecting pipes, such as connecting pipe 721b, and output manifolds.

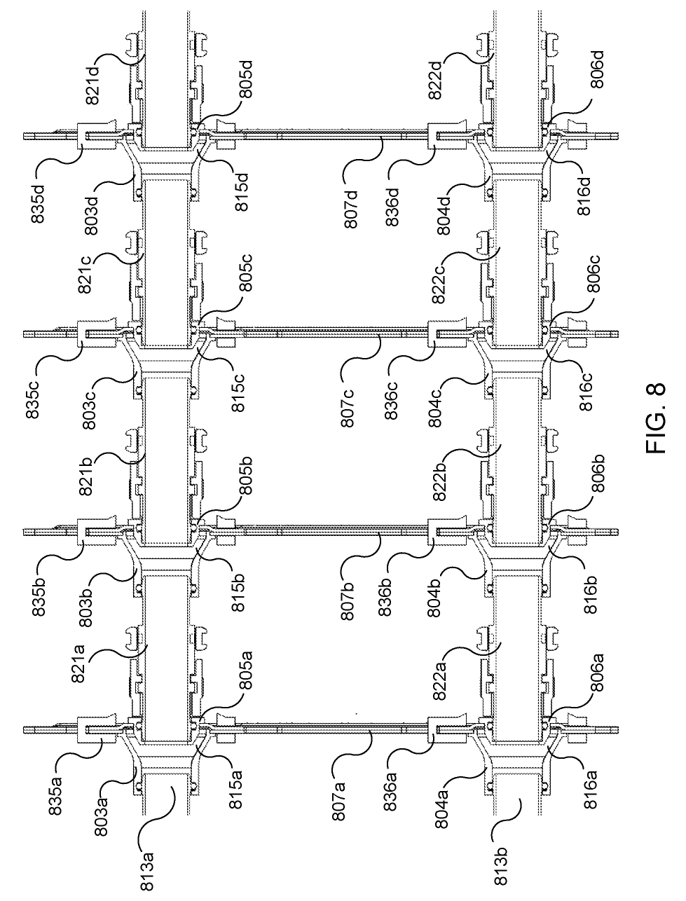

FIG. 8 is a cross-section view of a cooling system. The cooling system comprises cooling plates 807a, 807b, 807c, and 807d, connected together and connected to a fluid reservoir. The cooling plates include input fluid manifolds and outlet fluid manifolds. Each manifold includes a first fitting which attaches to a first side of a cooling plate and a second fitting which attaches to a second side of a cooling plate. The input manifolds have first fittings on a first side of the cooling plates and a second fitting on a second side of the cooling plate. First fitting 803a attaches to a first side of cooling plate 807a and second fitting 805a attaches to a second side of cooling plate 807a. First fitting 803b attaches to a first side of cooling plate 807b and second fitting 805b attaches to a second side of cooling plate 807b. First fitting 803c attaches to a first side of cooling plate 807c and second fitting 805c attaches to a second side of cooling plate 807c. First fitting 803d attaches to a first side of cooling plate 807d and second fitting 805d attaches to a second side of cooling plate 807d. The input fluid manifolds are connected together by connecting pipes 821a, 821b, and 821c. Second fitting 805a connects to connecting pipe 821a, which connects to first fitting 803b. Second fitting 805b connects to connecting pipe 821b, which connects to first fitting 803c. Second fitting 805c connects to connecting pipe 821c, which connects to first fitting 803d. The connecting pipes are secured to the second fittings by clips. The clips hold the pipes in place. The clips help ensure that the pipes will not come out of the fittings. Clip 835a secures connecting pipe 821a to the input fitting on cooling plate 807a. Clip 835b secures connecting pipe 821b to the input fitting on cooling plate 807b. Clip 835c secures connecting pipe 821c to the input fitting on cooling plate 807c. The first fittings, second fittings and connecting pipes form a main conduit 813a through which a fluid flows. Branching from the main conduit are distribution channels 815a, 815b, 815c, and 815d. The distribution channels are formed between the first fittings and the second fittings. The distribution channels transfer the fluid from the main conduit 813a into the cooling plates 807a, 807b, 807c, and 807d. main conduit 813a into the cooling plates 807a, 807b, 807c, and 807d.

The output manifolds have first fittings on a first side of the cooling plates and a second fitting on a second side of the cooling plate. First fitting 804a attaches to a first side of cooling plate 807a and second fitting 806a attaches to a second side of cooling plate 807a. First fitting 804b attaches to a first side of the cooling plate 807b and second fitting 806b attaches to a second side of cooling plate 807b. First fitting 804c attaches to a first side of the cooling plate 807c and second fitting 806c attaches to a second side of the cooling plate 807c. First fitting 804d attaches to a first side of the cooling plate 807d and second fitting 806d attaches to a second side of cooling plate 807d. The output fluid manifolds are connected together by connecting pipes 822a, 822b, and 822c. Second fitting 806a connects to connecting pipe 822a, which connects to first fitting 804b. Second fitting 806b connects to connecting pipe 822b, which connects to first fitting 804c. Second fitting 806c connects to connecting pipe 822c, which connects to first fitting 804d. The connecting pipes are secured to the second fittings by clips. The clips hold the pipes in place. The clips help ensure that the pipes will not come out of the fittings. Clip 836a secures connecting pipe 822a to the input fitting on cooling plate 807a. Clip 836b secures connecting pipe 822b to the input fitting on cooling plate 807b. Clip 836c secures connecting pipe 822c to the input fitting on cooling plate 807c. The first fittings, second fittings and connecting pipes form a main output conduit 813b through which a fluid flows. Branching from the cooling plates are output distribution channels 816a, 816b, 816c, and 816d. The output distribution channels 816a, 816b, 816c, and 816d are formed between the first fittings and the second fittings. The output distribution channels transfer the fluid from the cooling plates 807a, 807b, 807c, and 807d into the main output conduit 813b.

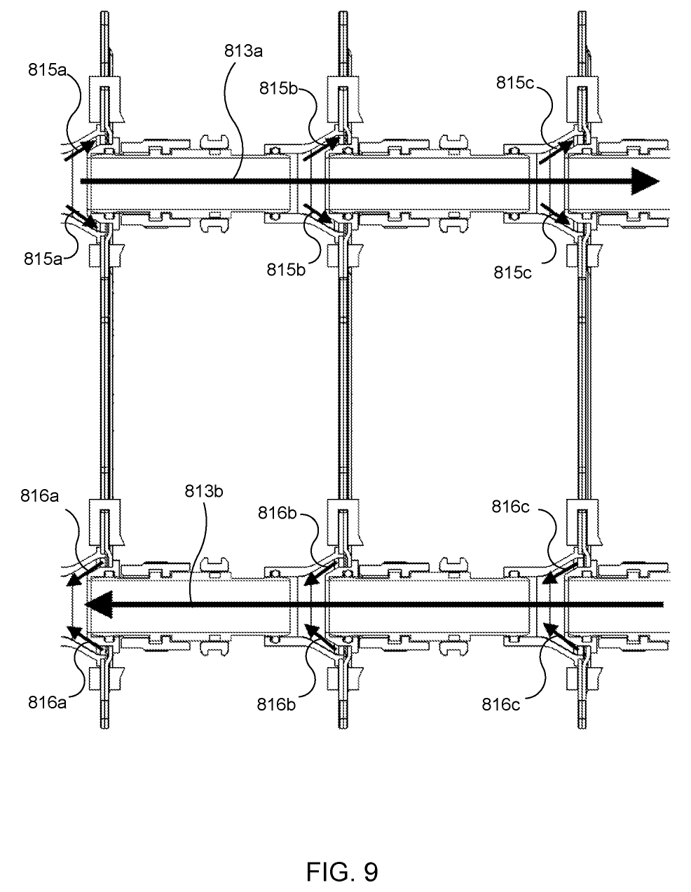

FIG. 9 is a cross-section view of a cooling system, with arrows indicating the flow of fluid. The cooling plate is a temperature regulation device. The cooling plate is used to lower the temperature near batteries. Each cooling plate is associated with a battery module. Batteries often produce heat when discharged or recharged. Batteries, particularly lithium-based batteries, operate most efficiently in specific temperature ranges. This temperature range is generally between 20℃ and 30℃. As temperatures rise above 30℃, the cell oxidation rate increases, which causes faster degradation of the battery, decline in performance, and reduced capacity of the battery. Lithium batteries operated at temperatures over 40℃ may lead to permanent battery damage. Maintaining the temperature of the battery between 20℃ and 30℃ increases the efficiency, life, and safety of the battery. The fluid flows into the system from a fluid reservoir. The fluid flows in through the main conduit 813a. The fluid passes through distribution channels 815a, 815b, and 815c into the cooling plates 807a, 807b, and 807c. The fluid passes through the cooling plates 807a, 807b, and 807c. The fluid provides a place for heat to dissipate, that is heat from batteries may be absorbed into the fluid in the cooling plates. The fluid passes from the cooling plates 807a, 807b, and 807c out through the output distribution channels 816a, 816b, and 816c to main output conduit 813b. In some implementations, heat transfer devices are used to reduce the heat in battery modules. In these implementations, the fluid runs through the heat transfer devices begins at a low temperature and is heated as the fluid passes by the batteries. In some implementations, the heat transfer devices are used to raise the temperature near the batteries. In these implementations, fluid begins at higher temperature than the batteries and transfers heat to the batteries. In some implementations, the heat transfer device heats and cools the batteries as needed to maintain a temperature at which the batteries will most efficiently operate.

The invention has been described with reference to various embodiments and techniques. Nevertheless, it is understood that many variations and modifications may be made while remaining within the spirit and scope of the invention.

What is claimed is:

1. A manifold for distributing a fluid comprising:
a first fitting with a first end and a second end, the first end comprising a pipe interface with a first internal diameter, through which a fluid flows, the second end comprising a chamber in which the first internal diameter increases to a second internal diameter;
a second fitting with an external surface which complements an inner surface of the chamber of the first fitting, and a pipe interface with same internal diameter as the pipe interface of the first fitting, and wherein the external surface of the second fitting and the internal surface of the chamber form a distribution channel through which the fluid flows; and
wherein the second fitting directs the fluid into the distribution channel.

2. The manifold of claim 1, further comprising a pipe connecting to the pipe interface.

3. The manifold of claim 2, wherein the pipe interface of the first fitting is configured to allow the pipe to be angularly misaligned when the pipe is inserted into the pipe interface of the first fitting and wherein the pipe interface of the second fitting is configured to allow the pipe to be angularly misaligned when the pipe is inserted into the pipe interface of the second fitting.

4. The manifold of claim 2, wherein the pipe interface of the first fitting is configured to allow the pipe to be axially misaligned when the pipe is inserted into the pipe interface of the first fitting and wherein the pipe interface of the second fitting is configured to allow the pipe to be axially misaligned when the pipe is inserted into the pipe interface of the second fitting.

5. The manifold of claim 3, further comprising seals within the pipe interface of the first fitting and the pipe interface of the second fitting.

6. The manifold of claim 1, wherein the first fitting and the second fitting further comprise a main conduit through which the fluid flows.

7. A system for moving a fluid through a heat transfer device comprising:
multiple heat transfer devices through which a fluid flows;
a first manifold attached to each heat transfer device comprising:
a first fitting on a first side of each heat transfer device;
a second fitting on a second side of each heat transfer device;
a conduit comprising the first fitting and the second fitting of each heat transfer device and a pipe connecting the second fitting of each heat transfer device to the first fitting of each subsequent heat transfer device; and
a distribution channel which transfers the fluid from the conduit into each heat transfer device, wherein walls of the distribution channel are formed by the first fitting and the second fitting of each heat transfer device, and wherein the second fitting directs the fluid from the conduit, through the distribution channel, to each heat transfer device.

8. The system of claim 7, wherein the pipe is secured to the second fitting.

9. The system of claim 7, further comprising a clip which secures the pipe to the manifold.

10. The system of claim 7, wherein the first fitting is configured to allow the pipe to be angularly misaligned when the pipe is inserted into the first fitting and wherein the second fitting is configured to allow the pipe to be angularly misaligned when the pipe is inserted into the second fitting.

11. The system of claim 7, wherein the first fitting is configured to allow the pipe to be axially misaligned when the pipe is inserted into the first fitting and wherein the second fitting is configured to allow the pipe to be axially misaligned when the pipe is inserted into the second fitting.

12. The system of claim 7, wherein the first fitting and the second fitting are affixed to each heat transfer device.

13. The system of claim 12, further comprising a second manifold attached to each heat transfer device.

14. The system of claim 13, wherein the fluid passes from the heat transfer device through the second manifold.

15. The system of claim 7, wherein each heat transfer device is a cooling plate.

16. The system of claim 15, wherein the cooling plate is integrated into a battery module.

17. A system for maintaining temperature of a battery system comprising:
a heat transfer device through which a fluid flows;
a manifold comprising:
a first fitting on a first side of the heat transfer device with a first end and a second end, the first end comprising a pipe interface with a first internal diameter, the second end comprising a chamber in which the first internal diameter increases to a second internal diameter,
a second fitting with an external surface which complements an inner surface of the chamber of the first fitting, and wherein the external surface of the second fitting and the internal surface of the chamber form a distribution channel; and
wherein the second fitting directs the fluid into the distribution channel.

18. The system of claim 17, wherein the first fitting and the second fitting are affixed to the heat transfer device.

19. The system of claim 17, wherein the pipe interface of the first fitting is configured to allow the pipe to be angularly misaligned when the pipe is inserted into the pipe interface of the first fitting and wherein the pipe interface of the second fitting is configured to allow the pipe to be angularly misaligned when the pipe is inserted into the pipe interface of the second fitting.

20. The system of claim 17, wherein the pipe interface of the first fitting is configured to allow the pipe to be axially misaligned when the pipe is inserted into the pipe interface of the first fitting and wherein the pipe interface of the second fitting is configured to allow the pipe to be axially misaligned when the pipe is inserted into the pipe interface of the second fitting.
